(19) United States
(12) Patent Application Publication
(10) Pub. No.: US 2018/0243877 A1
(43) Pub. Date: Aug. 30, 2018

(54) DOUBLE-FACE POLISHING DEVICE AND METHOD CAPABLE OF CONTROLLING RIGIDITY OF POLISHING PAD THROUGH CLUSTER DYNAMIC MAGNETIC FIELD

(71) Applicant: GUANGDONG UNIVERSITY OF TECHNOLOGY, Guangdong (CN)

(72) Inventors: Jisheng PAN, Guangdong (CN); Qiusheng YAN, Guangdong (CN); Weihua LI, Guangdong (CN)

(73) Assignee: GUANGDONG UNIVERSITY OF TECHNOLOGY, Guangdong (CN)

(21) Appl. No.: 15/555,073

(22) PCT Filed: Jan. 6, 2017
(86) PCT No.: PCT/CN2017/070456

§ 371 Date: Aug. 31, 2017

(30) Foreign Application Priority Data
Jun. 8, 2016 (CN) 201610406771.X

(51) Int. Cl. B24B 7/17; B24B 47/16; B24B 41/02; B24B 41/06; B24B 47/04; B24B 31/10; B24B 27/00; C09K 3/14

(52) U.S. Cl. CPC B24B 7/17; B24B 47/16; B24B 41/02; B24B 41/06; C09K 3/1454; B24B 31/102; B24B 27/0076; C09K 3/1409; B24B 47/04

(57) ABSTRACT

A double-face polishing device and a method capable of controlling rigidity of a polishing pad through a cluster dynamic magnetic field are provided. A whole process from double-face rough polishing to precision polishing of a workpiece is implemented by adjusting a rigidity of a flexible polishing pad. The double-face polishing device capable of controlling rigidity of a polishing pad through a cluster dynamic magnetic field includes a variable-rigidity cluster magnetically-controlled polishing pad generating mechanism, a workpiece fast clamping mechanism and a workpiece movement driving mechanism. The variable-rigidity cluster magnetically-controlled polishing pad generating mechanism includes a first magnetic field generating block and a second magnetic field generating block that are symmetrically arranged, wherein the first magnetic field generating block and the second magnetic field generating block each include a shell, a deflection spindle, an eccentric camshaft, a magnet mounting base, a permanent magnet and a motor, the workpiece fast clamping mechanism includes a working tank, a clamping plate, a connection rod, a hinge plate, a fixing hinge, a square magnet, an electrical soft iron block, an annular cast iron and a strip-shaped permanent magnet, and the workpiece movement driving mechanism includes a support block, a cross beam, a horizontal linear motor, a vertical beam and a vertical linear motor.

The present invention claims priority benefits from Chinese patent application No. 201610406771.X, titled “Double-Face Polishing Device And Method Capable Of Controlling Rigidity Of Polishing Pad Through Cluster Dynamic Magnetic Field”, filed with Chinese Patent Office on Jun. 8, 2016, the disclosure of which is hereby incorporated herein by reference.

### TECHNICAL FIELD

The present invention relates to a double-face polishing device and method capable of controlling rigidity of a polishing pad through a cluster dynamic magnetic field, which are particularly applicable to plane planarization machining of the photoelectronic/microelectronic semiconductor substrates and the optical elements, belonging to the technical field of super-precision machining.

### BACKGROUND

Microelectronic and photoelectronic manufacture represented by integrated circuit (IC) and photoelectronic devices manufacture is the core of the electronic and information industry, which is also an industry in the whole world that is under the most severe competition and highest development speed. Monocrystal silicon (Si), monocrystal germanium (Ge), gallium arsenide (GaAs), monocrystal silicon carbide (SiC), sapphire (Al₂O₃) and the like are used as substrate materials of the integrated power electronic devices and photoelectronic devices. Super-flat, super-smooth (with a roughness Ra of less than 0.3 nm), defect-free and damage-free surfaces are desired. The machining quality directly determines application value and performance of the devices. Likewise, in the optical field, optical lenses and mirrors are core elements of the optical devices. For a better optical performance, the surface precision thereof also needs to reach a super-smooth degree (with a roughness Ra less than 1 nm), and a higher requirement is also imposed on the surface figure thereof (with a shape precision less than 0.5 micron).

At present, planarization machining of the planar optical elements and semiconductor substrates mainly employs the traditional milling, end-face precision grinding, super-precision polishing, chemical mechanical polishing, magnetorheological polishing, and the like. The magnetorheological finishing (MRF) is a new optical surface machining method proposed by KORDOSKI and his collaborators, in combination of electromagnetics, fluid dynamics, analytical chemistry, machining processing technique and the like. The MRF achieves a good polishing effect, causes no sub-surface damage, and is applicable to complicated surface machining and the like which dwarfs the traditional polishing technique. Therefore, the MFR has been developed into a revolutionary optical surface machining method, which is particularly applicable to super-precision machining of axisymmetric aspheric surfaces, and has been widely applied to the final machining process of large-size optical elements, semiconductor chips, LED substrates, liquid crystal display panels and the like. However, at present, when planar workpieces are machined by using the magnetorheological finishing method, various models of magnetorheological machine tools developed by QED which is a corporation from the United States, are mainly used. The working principle lies in that a workpiece is placed above an arc-shaped polishing disk, a recessed gap is formed between the workpiece surface and the polishing disk, a magnetic induction strength adjustable electromagnet magnetic pole or a permanent magnet magnetic pole is arranged below the polishing disk, such that a high-strength gradient magnetic field is formed at the recessed gap, and the magnetorheological fluid moves with polishing disk and moves to the vicinity of the gap formed between the workpiece and the polishing disk, which forms a flexible projected “polishing ribbon” through which the surface material of the workpiece is removed. Based on this, the scholars abroad have developed the ball end magnetorheological finishing (BEMRF), magnetorheological abrasive flow finishing (MRAFF), magnetic compound fluid slurry polishing (MCF) and the like new technologies, which all achieve a very good effect on super-precision machining of the photoelectric crystal substrates. However, these methods all use the “polishing ribbon” to remove the surface material of the workpiece. The “polishing ribbon” is in “dot” partial contact with the surface of the workpiece. During machining of the planar workpiece, the entire surface may be machined only by controlling the “dot” to regularly perform trajectory scanning along the surface of the workpiece. The trajectory scanning takes a lot of time, and thus the efficiency is low, and the shape machining precision may not be definitely ensured. In addition, it is reported that the current magnetorheological finishing machining is only used in single-face machining of the workpiece.

### SUMMARY

Embodiments of the present invention provide a double-face polishing device and method capable of controlling rigidity of a polishing pad through a cluster dynamic magnetic field. A whole process from double-face rough polishing to precision polishing of a workpiece is implemented by adjusting a rigidity of a flexible polishing pad. The device and method according to the present invention are used to solve the problem that in the traditional finishing process, the workpiece finishing is not uniform due to inconsistent relative speeds between different positions of the workpiece and the polishing pad.

Embodiments of the present invention provide a double-face polishing device capable of controlling rigidity of a polishing pad through a cluster dynamic magnetic field, comprising: a variable-rigidity cluster magnetically-controlled polishing pad generating mechanism, a workpiece fast clamping mechanism and a workpiece movement driving mechanism; wherein

the variable-rigidity cluster magnetically-controlled polishing pad generating mechanism comprises a first magnetic field generating block and a second magnetic field generating block that are symmetrically arranged, the first magnetic field generating block and the second magnetic field generating block both comprising: a shell, a deflection spindle, an eccentric camshaft, a magnet mounting base, a permanent magnet and a motor; wherein

one ends of an even number of permanent magnets are mounted on the magnet mounting base having an even number of array holes, and the other ends of the even number of permanent magnets are mounted in an end face of the eccentric camshaft; a large end of the deflection spindle is connected to the eccentric camshaft and a shaft end of the deflection spindle is connected and fixed to the shell; and the motor is fixed on the shell, and drives the deflection spindle by using a transmission mechanism; and

the first magnetic field generating block and the second magnetic generating block move towards each other forward and backward under the effect of a opposing movement mechanism;

the workpiece fast clamping mechanism comprises a working tank, a clamping plate, a connection rod, a hinge plate, a fixing hinge, a square magnet, an electrical soft iron block, an annular cast iron and a strip-shaped permanent magnet; wherein

the working tank is arranged between the first magnetic field generating block and the second magnetic field generating block, a machining space accommodating a workpiece being formed in a middle part of the working tank; two ends of the working tank are each provided with the clamping plate, an outer side face of the clamping plate being movably connected to an inner wall of the working tank via two parallel connection rods; the inner wall of the working tank, the clamping plate, and the two corresponding connection rods form a parallelogram; an annular structure, formed between two end faces of the clamping plate, stretches into the machining space to clamp the workpiece, one end of the clamping plate being movably connected to one end of the hinge plate, and the other end of the hinge plate being connected to one end of the fixing hinge via a movable hinge; the other end of the fixing hinge is fixedly connected to a square protection sleeve provided with the square magnet; two electrical soft iron blocks are arranged at the two ends of the working tank, and are arranged to match with two square magnets; and the two electrical soft iron blocks are connected to a cuboid having a cylindrical hole in a middle part via brass, the cylindrical hole is provided with the annular cast iron, and the bar permanent magnet is arranged in the annular cast iron; and

the workpiece movement driving mechanism comprises a support block, a cross beam, a horizontal linear motor, a vertical beam and a vertical linear motor; wherein the support block is symmetrically arranged above a base of the double-face polishing device, two ends of the horizontal linear motor above which the cross beam is mounted are fixed to an upper part of the support block, the vertical beam is fixed and mounted on two ends of the cross beam, the vertical linear motor is mounted on the vertical beam, and left and right side faces of the working tank are fixed to the vertical linear motor.

Optionally, the opposing movement mechanism comprises a translational linear motor, a precision double-sided rack and two precision single-sided racks; wherein

the translational linear motor is mounted above the base, the precision double-sided rack having a symmetric structure is mounted on the translational linear motor, and two sides of the precision double-sided rack are respectively engaged with the two precision single-side racks via a gear; and the two precision single-sided racks are mounted on the base via a front and rear linear guide rail, and are respectively arranged on the two sides of the precision double-sided rack; and

the shells of the first magnetic field generating block and the second magnetic field generating block are respectively connected to the precision double-sided rack and the two precision single-sided racks.

Optionally, the transmission mechanism comprises a small pulley, a large pulley, a small flat key, a large flat key and a V-shaped belt; wherein

the small pulley is fixed to the motor shaft of the motor via the small flat key and the large pulley is fixed to deflection spindle via the large flat key, and the small pulley and the large pulley are connected via the V-shaped belt.

Optionally, a spindle eccentricity is present at a shaft-end bearing of the deflection spindle, and a camshaft eccentricity is present at a small-shaft-end bearing of the eccentric camshaft, wherein the spindle eccentricity and the camshaft eccentricity have the same value but have opposite eccentric directions.

Optionally, the permanent magnet has a magnetic field strength of between 1000 Gs and 5500 Gs, the square magnet has a magnetic field strength of between 200 Gs and 1200 Gs, the strip-shaped permanent magnet has a magnetic field strength of between 2000 Gs and 4000 Gs, neighboring cylindrical permanent magnets mounted on the same magnetic mounting base are distributed with opposite polarities, and cylindrical permanent magnets mounted on different magnetic mounting bases are arranged in mutually opposed pairs and are anisotropic in approximation to short magnetic poles.

Optionally, the workpiece fast clamping mechanism further comprises a circular retaining frame configured to receive the workpiece, and a left gear, a right gear, an upper gear and a lower gear arranged in the periphery of the circular retaining frame and engaging with an arc side of the circular retaining frame; wherein

the left gear, the right gear, the upper gear and the lower gear are mounted in the working tank, the left gear and the right gear are symmetrically mounted, and the upper gear and the lower gear are symmetrically mounted; and

at least one of the left gear, the right gear, the upper gear and the lower gear is connected to a step motor.

Embodiments of the present invention further provide a double-face polishing method capable of controlling rigidity of a polishing pad through a cluster dynamic magnetic field, which is applied in the double-face polishing device capable of controlling rigidity of a polishing pad through a cluster dynamic magnetic field as defined above. The method comprises:

step 1: selecting a permanent magnet having a corresponding magnetic field strength according to a dimension and material properties of a workpiece, and adjusting a position of a strip-shaped permanent magnet such that a magnetic pole direction of the strip-shaped permanent magnet is vertical to a square permanent magnet;

step 2: placing the workpiece into a working tank and causing an edge of the workpiece to be arranged between clamping plates, adjusting the position of the strip-shaped permanent magnet, such that the magnetic pole direction of the strip-shaped permanent magnet is consistent with that of the square magnet, an electrical soft iron block is quickly magnetized under the effect of the strip-shaped permanent magnet and generates a suction force to tightly retain the square magnet, whereby the clamping plates are pulled to generate a clamping force to clamp the workpiece under a collaborative effect of a hinge plate, the clamping plate, a fixing hinge and a connection rod;

step 3: adding into deionized water at least two abrasives of the three abrasives including a micron-scale abrasive having a concentration of 3% to 8%, a sub-micron-scale abrasive having a concentration of 3% to 10% and a nano-scale abrasive having a concentration of 2% to 10%, and adding into the deionized water a sub-micron-scale carbonyl iron powder having a concentration of 5% to 20% and a micro-scale carbonyl iron powder having a concentration of 5% to 25%, and adding a dispersant having a concentration of 3% to 15% and a rust inhibitor having a concentration of 1% to 6%, sufficiently stirring and performing ultrasonic vibration for 5 to 30 minutes, then selectively adding a chemical liquid having a concentration of 1% to 10% that is capable of reacting with the workpiece and selectively adding a catalyst that is capable of accelerating the reaction of the workpiece with the chemical liquid, and then performing ultrasonic vibration for 2 to 10 minutes to form a magnetorheological fluid;

step 4: pouring the magnetorheological fluid into the working tank such that the magnetorheological overflows the workpiece, adjusting a distance from an end face of the magnet mounting base to front and rear sides of the working tank to be within 0.5 mm to 10 mm by using the opposing movement mechanism such that the magnetorheological fluid is quickly cured into a flexible polishing pad under the effect of an array of the permanent magnets, and a staggered symmetric arrangement structure of the magnetic poles implements pressure balance of the workpiece;

step 5: starting a motor to drive a deflection spindle to eccentrically swing around a spindle eccentricity, wherein the eccentric swinging of the deflection spindle causes each eccentric camshaft and a cylindrical permanent magnet to rotate simultaneously, such that the static magnetic field line of an end face of the cylindrical permanent magnet is transformed into a dynamic magnetic field line;

step 6: starting a horizontal linear motor and a vertical linear motor to drive the working tank and the workpiece to move, such that the workpiece and the flexible polishing pad formed by the magnetorheological fluid are subjected to a planar relative movement in a predetermined trajectory, and the flexible polishing pad formed by the magnetorheological fluid mechanically removes materials on both surfaces and a corrosion layer of the workpiece simultaneously;

step 7: during the finishing, by adjustment using the opposing movement mechanism, gradually increasing the distance from the end face of the magnet mounting base to the front and rear sides of the working tank, such that a rigidity of the flexible polishing pad formed by the magnetorheological fluid is further lowered, the force applied to the workpiece is reduced, and a process from rough finishing to precision finishing is completed; and

Step 8: stopping the horizontal linear motor, the vertical linear motor and the motor, adjusting the position of the strip-shaped permanent magnet such that the magnetic pole direction of the strip-shaped permanent magnet is opposite to the magnetic pole direction of the square magnet, releasing and taking out the workpiece.

Optionally, the workpiece is a glass substrate, a monocrystal SiC substrate, a monocrystal Si substrate, a sapphire substrate, a polycrystal semiconductor substrate, a ceramic substrate or a metal substrate.

As seen from the above technical solutions, embodiments of the present invention have the following advantages:

In the double-face polishing device capable of controlling rigidity of a polishing pad through a cluster dynamic magnetic field according to the present invention, firstly, by means of smartly utilizing the feature of quick magnetization and demagnetization of the soft magnetic material, and the feature that the magnetic field is weak in the middle and the magnetic fields at two ends are stronger in a strip-shaped permanent magnet, a parallelogram clamping mechanism having a weak magnetic pole as a primer quickly clamps the workpiece in a closed space.

Secondly, the present invention innovatively uses the opposing movement mechanism to control the distances from the magnetic field generating blocks on two sides to the workpiece to be equal to each other; when the magnetorheological fluid enters the working tank, and a viscoelastic magnetorheological effect polishing pad having equal pressures on the two sides and causing constraint and aggregation on the abrasive behaviors is formed, which ensures smooth double-face polishing of the workpiece. In addition, it is innovative to implement the swinging of the deflection spindle via the eccentric camshaft structure, and the swinging of the deflection spindle implements rotation of a plurality of eccentric camshafts having the same eccentricity, such that a plurality of close arrays of permanent magnets simultaneously rotate to cause the static magnetic field line of the end face of the magnetic pole to transform into an intersecting dynamic magnetic field line which enables the flexible polishing pad fouled by the magnetorheological fluid to be dynamically distributed. In this way, the rigidity of the flexible polishing pad is lowered and the properties of the flexible polishing pad are recovered.

During machining, by symmetrically adjusting the distance from the end face of the variable-rigidity cluster magnetically-controlled polishing pad generating mechanism to surfaces of the workpiece, the entire process from double-face rough finishing to precision finishing of the workpiece may be completed via one-time machining. The complicated movement trajectory is acquired for the workpiece by a combination of the horizontal linear motor and the vertical linear motor. This prevents the problem that during the machining, the workpiece finishing is not uniform due to inconsistent relative speeds between different positions of the workpiece and the polishing pad.

In addition, the double-face polishing device capable of controlling rigidity of a polishing pad through a cluster dynamic magnetic field according to the present invention is applicable to common magnetorheological double-face polishing and magnetorheological chemical mechanical double-face polishing. The desired magnetorheological fluid only needs to be filled to an extremely tiny closed working space, which greatly reduces the cost of the consumable materials. It is apparent that the present invention acquires good workpiece surface consistence, achieves a high machining efficiency, causes no surface and sub-surface damages, and has a low cost, which is thus very applicable to high-efficiency super-smooth planar uniform polishing and finishing of optical elements having a greater diameter.

### BRIEF DESCRIPTION OF THE DRAWINGS

FIG. 1 is a front view of a double-face polishing device capable of controlling rigidity of a polishing pad through a cluster dynamic magnetic field according to an embodiment of the present invention;

FIG. 2 is a schematic structural view of an A-A section taken from a top view of FIG. 1;

FIG. 3 is a schematic structural view of a B-B section taken from a top view of FIG. 1;

FIG. 4 is a left view of a double-face polishing device capable of controlling rigidity of a polishing pad through a cluster dynamic magnetic field according to an embodiment of the present invention;

FIG. 5 is a front view illustrating clamping of a square workpiece in the double-face polishing device capable of controlling rigidity of a polishing pad through a cluster dynamic magnetic field according to an embodiment of the present invention; and

FIG. 6 is a front view illustrating clamping of a circular workpiece in the double-face polishing device capable of controlling rigidity of a polishing pad through a cluster dynamic magnetic field according to an embodiment of the present invention.

### DETAILED DESCRIPTION

Embodiments of the present invention provide a double-face polishing device and method capable of controlling rigidity of a polishing pad through a cluster dynamic magnetic field. A whole process from double-face rough polishing to precision polishing of a workpiece is implemented by adjusting a rigidity of a flexible polishing pad. The device and method according to the present invention are used to solve the problem that in the traditional finishing process, the workpiece finishing is not uniform due to inconsistent relative speeds between different positions of the workpiece and the polishing pad.

To make the objectives, technical features, and advantages of the present invention clearer and more understandable, the technical solutions according to the embodiments of the present invention are further described in detail with reference to the accompany drawings. Apparently, the embodiments described herein are merely some exemplary ones, rather than all the embodiments of the present invention. Based on the embodiments of the present invention, all other embodiments derived by persons of ordinary skill in the art without any creative efforts shall fall within the protection scope of the present invention.

### Embodiment 1

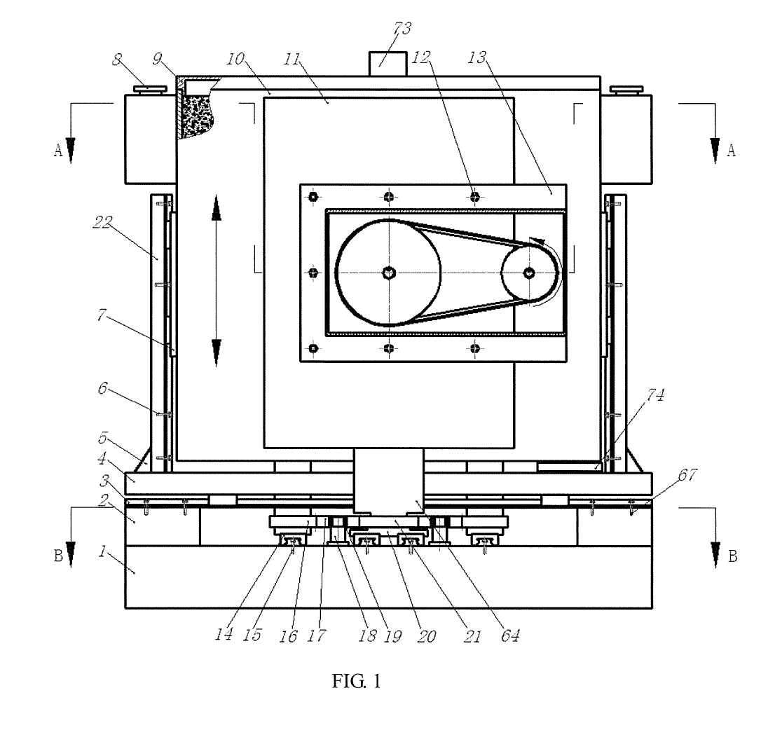

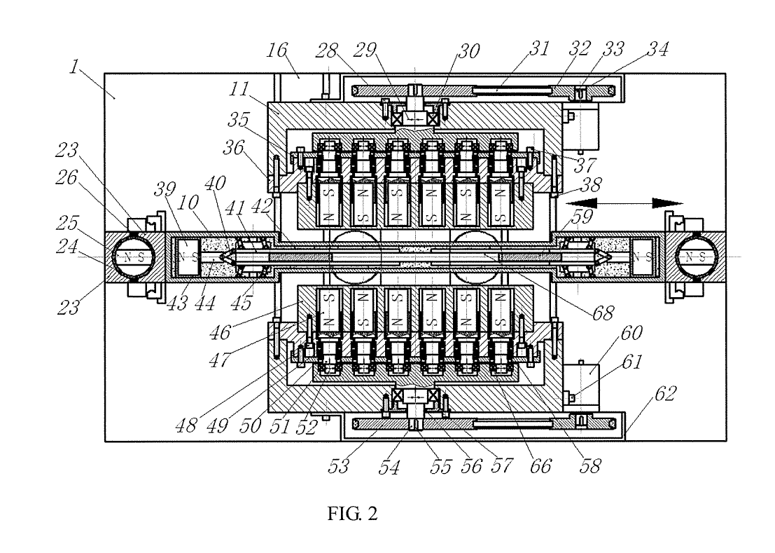

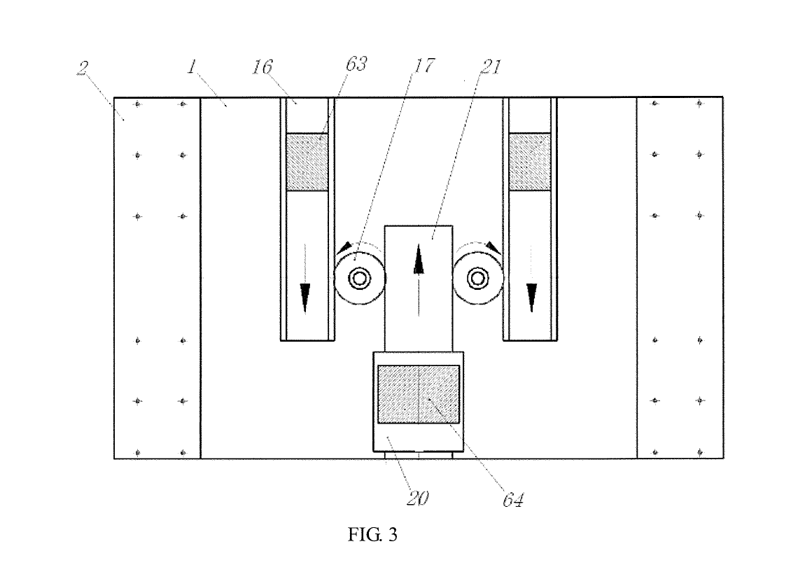

As illustrated in FIG. 1 and FIG. 2, a double-face polishing device capable of controlling rigidity of a polishing pad through a cluster dynamic magnetic field comprises a variable-rigidity cluster magnetically-controlled polishing pad generating mechanism, a workpiece fast clamping mechanism and a workpiece movement driving mechanism; wherein the variable-rigidity cluster magnetically-controlled polishing pad generating mechanism comprises a base (1), a screw II (12), a linear guiding rail (14), a screw III (15), a precision single-sided rack (16), a gear (17), a gear shaft (18), a deep groove bearing (19), a precision double-sided rack (21), a connection plate I (63), a connection plate II (64), a groove-shaped end cap (9), a shell (11), a screen IV (28), a spindle eccentricity (29), a rolling bearing (30), a V-shaped belt (31), a small pulley (32), a motor shaft (33), a small flat key (34), a bearing cover plate (35), a bearing base plate (36), a screw V (32), a screw VI (38), a magnet mounting base (46), a cylindrical permanent magnet (47), a screw VII (48), a spacer sleeve (49), a volt (50), an eccentric camshaft (51), a camshaft eccentricity (52), a large pullet (53), a deflection spindle (54), a large flat key (55), a sealing ring (56), a bearing end cap (57), a radial pushing bearing (58), a motor (60), a screw VIII (61), a protection cap (62), a screw IX (65), and a deep groove ball bearing (66). As illustrated in FIG. 3, a translational linear motor (20) is mounted over the base (1) via the screw IX (65), wherein the precision double-sided rack (21) having a symmetric structure is mounted on the translational linear motor (20), and two sides of the precision double-sided rack (21) are respectively engaged with two gears (17) that are fixed to the gear shaft (18) via the deep groove bearing (19); the linear guiding rail (14) is parallelly and symmetrically arranged on the two sides of the translational linear motor (20), and fixed to an upper part of the base via the screw III (15), and the precision single-sided rack (16) arranged above the linear guiding rail (14) is just engaged with the gear (17). As illustrated in FIG. 2, one end of the cylindrical permanent magnet (47) is mounted in an end-face cylindrical hole of the eccentric camshaft (51) by means of interference fitting; the magnet mounting base (46) having an even number of array holes is fixed to the bearing base (36) via the screw VII (48); the eccentric camshaft (51) is fixed to the bearing base plate (36) via the radial pushing bearing (58), the spacer sleeve (49), the bolt (50), the bearing cover plate (35) and the screw V (37); a large end of the deflection spindle (54) is connected to the eccentric camshaft (51) via the deep groove ball bearing (66), and a shaft end of the deflection spindle (54) is connected to the shell (11) via the rolling bearing (30) and is fixed to the shell (11) via the screw IV (28) and the bearing end cap (57); the shell (11) is fixed to the bearing base plate (36) via the screw VI (38); a lower part of one shell (11) is connected to an upper part of the precision single-sided rack (16) via the connection plate I (63), and another shell (11) is connected to an upper part of the precision double-sided rack (21) via the connection plate II (64); the motor (60) is fixed to an upper side face of the shell (11) via the screw VIII (61); the small pulley (32) is fixed to the motor shaft (33) via the small flat key (34) and the large pulley (53) is fixed to the deflection spindle (54) via the large flat key (55), and the small pulley (32) and the large pulley (53) are connected via the V-shaped belt (31); the protection cap (62) is fixed to the shell (11) via the screw II (12); a left gear (69) and a right gear (70) are symmetrically mounted on the left and right sides in the interior of a working tank (10); an upper gear (71) is mounted on a lower side in the interior of a groove-shaped end cap (9) and is connected to a step motor (73); a lower gear (72) is mounted on a lower side in the interior of the working tank (10). The workpiece fast clamping mechanism comprises a working tank (10), a square magnet (39), a hinge plate (40), a clamping plate (41), a protection sleeve (43), a fixing hinge (44), a connection rod (45), an electrical soft iron block (23), an annular cast iron (24), a strip-shaped permanent magnet (25), a brass (26), a rotatable handle (8); wherein one end of the connection rod (45) is connected to an inner wall of the working tank (10) via a movable hinge, and the other end of the connection rod (45) is connected to a side face of the clamping plate (41) via the movable hinge; the inner wall of the working tank, the clamping plate (41), and the two connection rods (45) form a parallelogram; two parallelograms are respectively symmetrically arranged on two sides of the inner wall of the working tank (10); one end of the clamping plate (41) is connected to the hinge plate (40) via the movable hinge, and the other end of the hinge plate (40) is connected to the fixing hinge (44) via the movable hinge; the other end of the fixing hinge (44) is welded to the square protection sleeve (43); a square magnet (39) is mounted inside the protection sleeve (43); two arch-shaped electrical soft iron blocks (23) are connected to a cuboid having a cylindrical hole in a middle part via the brass (26), the cylindrical hole is provided with the annular cast iron (24), and the strip-shaped permanent magnet (25) provided with the rotatable handle (8) is mounted in the annular cast iron (24); and a plane of the electrical soft iron block (23) is fixed to upper sides of two ends of the working tank (10).

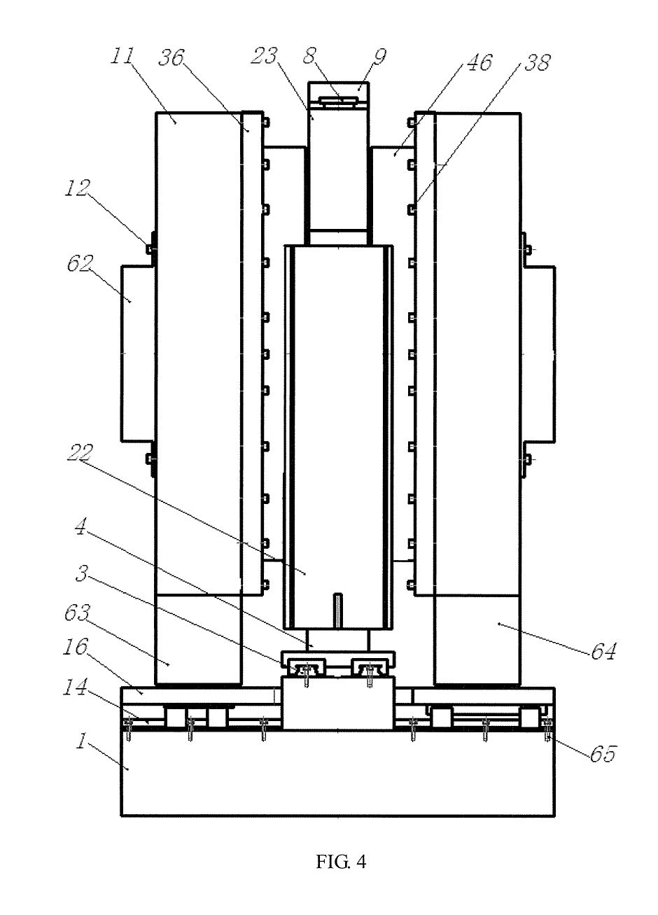

As illustrated in FIG. 1 and FIG. 4, the workpiece movement driving mechanism comprises a base (1), a support block (2), a horizontal linear motor (3), a cross beam (4), a rib plate (5), a screw I (6), a vertical linear motor (7), a working tank (10), a vertical beam (22), and a screw X (67); wherein the support block (2) is symmetrically arranged above the base (1), two ends of the horizontal linear motor (3) above which the cross beam (4) is mounted are fixed to an upper part of the support block (2) via the screw X (67), the vertical beam (22) is fixed and mounted on two ends of the cross beam (4) via the rib plate (5), the vertical linear motor (7) is arranged on the vertical beam (22), and left and right side faces of the working tank (10) are fixed to the vertical linear motor (7).

In the double-face polishing device capable of controlling rigidity of a polishing pad through a cluster dynamic magnetic field, the magnet mounting base (46) of the variable-rigidity cluster magnetically-controlled polishing pad generating mechanism is symmetrically arranged on the front and rear sides of the working tank (10), a distance from an end face of the magnet mounting base (46) to front and rear sides of the working tank (10) may be simultaneously adjusted by using the translational linear motor (20), such that the distances from the two magnet mounting bases (46) to the working tank (10) remain consistent.

In the double-face polishing device capable of controlling rigidity of a polishing pad through a cluster dynamic magnetic field, the spindle eccentricity (29) is present at a shaft-end bearing of the deflection spindle (54), and the camshaft eccentricity (52) is present at a small-shaft-end bearing of the eccentric camshaft (51), wherein the spindle eccentricity (29) and the camshaft eccentricity (52) have the same value. When the motor (60) operates, the deflection spindle (54) is driven via the small pulley (32), the large pulley (53) and the V-shaped belt (31) to eccentrically swing around the spindle eccentricity (29). The eccentric swinging of the deflection spindle (54) causes the eccentric camshafts (51) and the cylindrical permanent magnet (47) to rotate simultaneously, such that the static magnetic field line of an end face of the cylindrical permanent magnet (47) is transformed into a dynamic magnetic field line.

In the double-face polishing device capable of controlling rigidity of a polishing pad through a cluster dynamic magnetic field, the cylindrical permanent magnet (47) has magnetic field strength of between 1000 Gs and 5500 Gs, the square magnet (39) has a magnetic field strength of between 200 Gs and 1200 Gs, and the strip-shaped permanent magnet (25) has a magnetic field strength of between 2000 Gs and 4000 Gs. Neighboring cylindrical permanent magnets (47) mounted on the same magnetic mounting base (46) are distributed with opposite polarities, and cylindrical permanent magnets (47) mounted on different magnetic mounting bases (46) are arranged in mutually opposed pairs and are anisotropic in approximation to short magnetic poles.

In the double-face polishing device capable of controlling rigidity of a polishing pad through a cluster dynamic magnetic field according to this embodiment, the working tank (10), the hinge plate (40), the clamping plate (41), the fixing hinge (44), the connection rod (45), the shell (11), the bearing cover plate (35), the bearing base plate (36), the magnet mounting base (46), the spacer sleeve (49), the bolt (50), the eccentric camshaft (51), the deflection spindle (54), and the groove-shaped end cap (9) are made from a stainless steel, a magnesium-aluminum alloy, a ceramic or the like non-magnetically conductive material. The working tank (10), the hinge plate (40), the clamping plate (41), the fixing hinge (44), the connection rod (45), and the groove-shaped end cap (9) are made from a stainless steel material.

In the double-face polishing device capable of controlling rigidity of a polishing pad through a cluster dynamic magnetic field according to this embodiment, the left gear (69), the right gear (70), the upper gear (71) and the lower gear (72) have the same parameter; a distance between the left gear (69) and the right gear (70) is just equal to a distance between the upper gear (71) and the lower gear (72) when the groove-shaped end cap (9) is properly mounted, such that the left gear (69), the right gear (70), the upper gear (71) and the lower gear (72) are engaged with a retaining frame (59). When the step motor (73) operates, the upper gear (71) is driven to rotate, and the upper gear (71) drives the retaining frame (59) to rotate. In the meantime, the retaining frame (51) drives the left gear (69), the right gear (70) and the lower gear (72) to rotate, such that the retaining frame drives the workpiece (68) to rotate while rotating, thereby implementing rotational motion of the workpiece. In this way, the portion shaded by the clamping plate (41) may also be machined, which achieves equal machining of the workpiece (68).

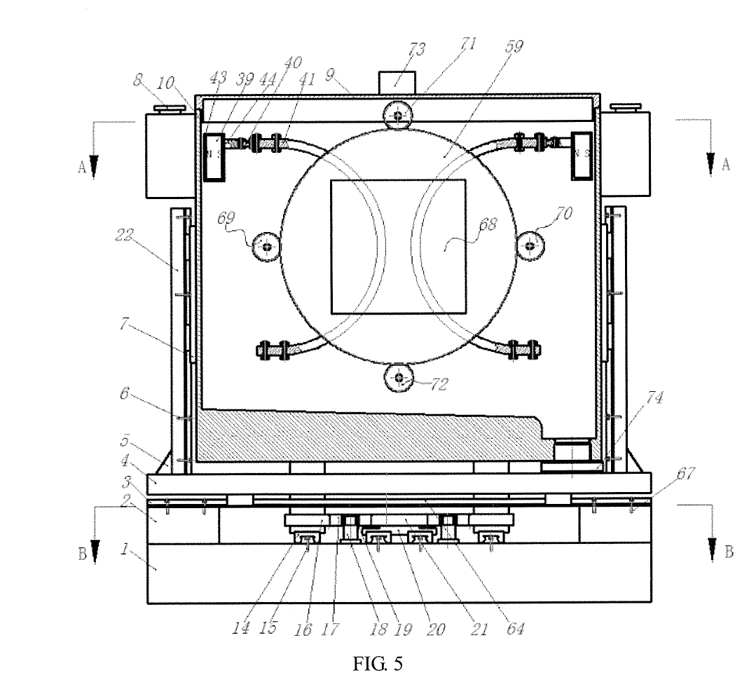

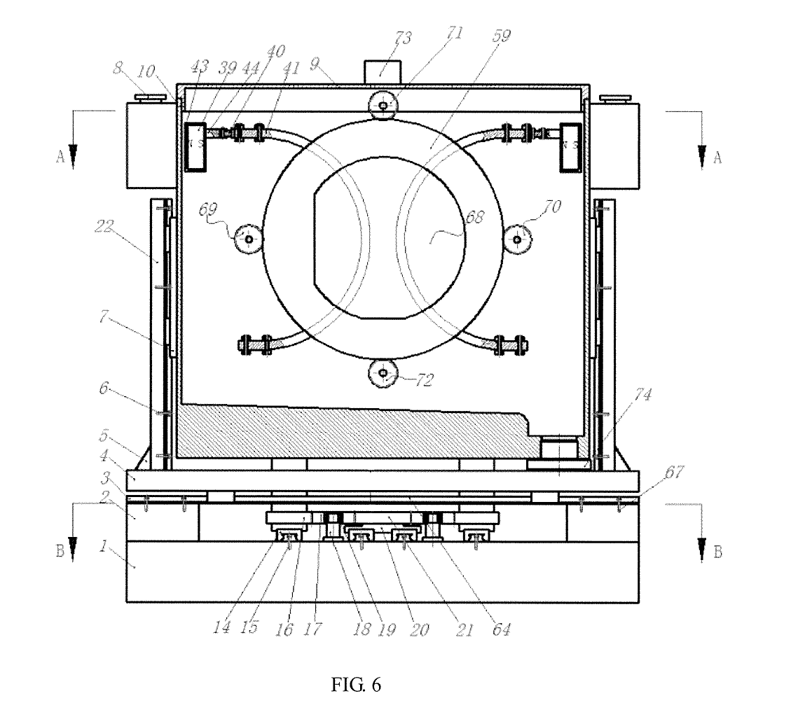

In the double-face polishing device capable of controlling rigidity of a polishing pad through a cluster dynamic magnetic field according to this embodiment, the clamping plate (41) may be an arc long strip-shaped structure as illustrated in FIG. 5 and FIG. 6. Since the retaining frame (59) and the workpiece (68) may obstruct the clamping plate (41), the clamping plate (41) is designed to the arc long strip-shaped structure so as to ensure that the clamping plate (41) has a minimum area such that the retaining frame (59) and the workpiece (68) are tightly clamped, and the portions of the workpiece (68) that are not under clamping are machined by means of a magnetorheological fluid.

In the double-face polishing device capable of controlling rigidity of a polishing pad through a cluster dynamic magnetic field according to this embodiment, a larger inclination is present on a lower bottom face facing the right side of the working tank (10), and a threaded through hole mating with the bolt (74) is provided at the right corner.

### Embodiment 2

Double-face polishing of a square TFT-LCD glass substrate having a dimension of 100 mm×100 mm by using the double-face polishing method capable of controlling rigidity of a polishing pad through a cluster dynamic magnetic field comprises the following steps:

1) according to the dimension and material properties of the TFT-LCD glass substrate, designing a double-face polishing device capable of controlling rigidity of a polishing pad through a cluster dynamic magnetic field that matches with the dimension of the workpiece, selecting a cylindrical permanent magnet (47) having a diameter of 10 mm, a height of 15 mm and a magnetic field strength of 3800 Gs and mounting the cylindrical permanent magnet (47) into the double-face polishing device capable of controlling rigidity of a polishing pad through a cluster dynamic magnetic field, rotating a rotatable handle (8) such that a magnetic pole direction of a strip-shaped permanent magnet (25) is vertical to that of a square magnet (39), and fabricating a circular retaining frame which is adaptive to the workpiece in terms of shape and thickness;

2) according to the shape of the TFT-LCD glass substrate, selecting an acid and alkaline corrosion resistant plastic to fabricate the retaining frame (59), and ensuring that the thickness of the retaining frame (59) is ⅔ of the workpiece, and the modulus there of is the same as that of the left gear (69);

3) as illustrated in FIG. 5, fixing and placing the TFT-LCD glass substrate into a middle matched hole of the circular retaining frame via the retaining frame (59) and placing the TFT-LCD glass substrate between the clamping plates (41) in the working tank (10) such that the retaining frame (59) is engaged with the left gear (69), the right gear (70) and the lower gear (72) under the effect of gravity, rotating the rotatable handle (8) such that the magnetic pole direction of the strip-shaped permanent magnet (25) is consistent with the magnetic pole direction of the square magnet (39) and the arch-shaped electrical soft iron block (23) is quickly magnetized under the effect of the strip-shaped permanent magnet (25) and generates a suction force to tightly retain the square magnet (39), whereby the clamping plates (41) are pulled to generate a clamping force to clamp the TFT-LCD glass substrate and fix the retaining frame (59) under a collaborative effect of the hinge plate (40), the clamping plate (41), the fixing hinge (44) and the connection rod (45);

4) adding into deionized water a micron-scale alumina abrasive having a concentration of 4% and a sub-micron-scale alumina abrasive having a concentration of 3%, adding into the deionized water a sub-micron-scale carbonyl iron powder having a concentration of 8% and a micron-scale carbonyl iron powder having a concentration of 5%, and adding a dispersant having a concentration of 5% and a rust inhibitor having a concentration of 2%, sufficiently stirring and performing ultrasonic vibration for 15 minutes, then adding an aqua regia having a concentration of 3% that is capable of reacting with the TET-LCD glass substrate, and then performing ultrasonic vibration for 5 minutes to form the magnetorheological fluid (42);

5) pouring the magnetorheological fluid (42) into the working tank (10) such that the magnetorheological fluid overflows the workpiece (68), putting on the groove-shaped end cap (9), starting the translational linear motor (20) to adjust a distance from an end face of the magnet mounting base (46) to front and rear sides of the working tank (10) to be within 2 mm such that the magnetorheological fluid is quickly cured into a flexible polishing pad under the effect of an array of the cylindrical permanent magnets (47), and a staggered symmetric arrangement structure of the magnetic poles implements pressure balance of the workpiece (68);

6) starting the step motor (73) to drive the upper gear (71) to rotate to and drive the fixed retaining frame (59) and the workpiece (68) to rotate, and meanwhile drive the motor (60) to operate, driving the deflection spindle (54) to eccentrically swing around the spindle eccentricity (29) under the effect of the small pulley (32), the large pulley (53) and the V-shaped belt (31), wherein the eccentric swinging of the deflection spindle (54) causes the eccentric camshafts and the cylindrical permanent magnet (47) to rotate simultaneously, such that the static magnetic field line of an end face of the cylindrical permanent magnet (47) is transformed into a dynamic magnetic field line, and the dynamic magnetic field line enables a dynamic distribution of the flexible polishing pad formed by the magnetorheological fluid (42), thereby lowering the rigidity of the flexible polishing pad and recovering the properties of the flexible polishing pad such that the abrasive is self-sharpened;

7) putting on the groove-shaped end cap such that the gear is engaged with the circular retaining frame, starting the step motor to drive the circular retaining frame and the workpiece to rotate, starting the horizontal linear motor (3) and the vertical linear motor (7) to drive the working tank (10) and the workpiece (68) to achieve an Archimedean planar motion, such that the TFT-LCD glass substrate and the flexible polishing pad formed by the magnetorheological fluid (42) form a complicated waterfall-like motion, the surface material of the TFT-LCD glass substrate is quickly corroded under the effect of the aqua regia, and the flexible polishing pad formed by the magnetorheological fluid (42) mechanically removes a corrosion layer and the surface material of the TFT-LCD glass substrate simultaneously;

8) during machining, starting the translational linear motor (20) to adjust the distance from the end face of the magnet mounting base (46) to front and rear sides of the working tank (10) to gradually change from 2 mm to 10 mm within 60 minutes, such that the rigidity of the flexible polishing pad formed by the magnetorheological fluid (42) is gradually lowered, and the force applied to the workpiece (68) is reduced, and a process from rough finishing to precision finishing of the TFT-LCD glass substrate is completed;

9) stopping the horizontal linear motor (3) and the vertical linear motor (7), stopping the motor (60) and the step motor, taking off the groove-shaped cap, rotating the rotatable handle (8) such that the magnetic pole direction of the strip-shaped permanent magnet (25) is opposite to the magnetic pole direction of the square magnet (39), the arch-shaped electrical soft iron block (23) is quickly magnetized under the effect of the strip-shaped permanent magnet (25) and generates a force to push the square magnet (39), whereby the clamping plate (41) is pushed to open so as to release the TFT-LCD glass substrate under a collaborative effect of the hinge plate (40), the clamping plate (41), the fixing hinge (44) and the connection rod (45), and taking the finished TFT-LCD glass substrate; and

10) upon completion of the finishing, starting the translational linear motor (20) to adjust the distance from the end face of the magnet mounting base (46) to the front and rear sides of the working tank (10) to be 10 mm, releasing the bolt (74), and discharging the magnetorheological fluid (42) completing finishing from the working tank (10).

### Embodiment 3

This embodiment is different from Embodiment 2 in that: In this embodiment, double-face polishing is performed for a monocrystal silicon substrate having a diameter of 100 mm, and the method performed by the double-face polishing device capable of controlling rigidity of a polishing pad through a cluster dynamic magnetic field comprises the following steps:

1) according to the dimension and material properties of the monocrystal silicon substrate, designing a double-face polishing device capable of controlling rigidity of a polishing pad through a cluster dynamic magnetic field that matches with the dimension of the workpiece, selecting a cylindrical permanent magnet (47) having a diameter of 15 mm, a height of 15 mm and a magnetic field strength of 4200 Gs and mounting the cylindrical permanent magnet (47) into the double-face polishing device capable of controlling rigidity of a polishing pad through a cluster dynamic magnetic field, rotating a rotatable handle (8) such that a magnetic pole direction of a strip-shaped permanent magnet (25) is vertical to that of a square magnet (39), and fabricating a circular retaining frame which is adaptive to the workpiece in terms of shape and thickness;

2) according to the shape of the monocrystal silicon substrate, selecting an acid and alkaline corrosion resistant plastic to fabricate the retaining frame (59), and ensuring that the thickness of the retaining frame (59) is ⅔ of the workpiece, and the modulus there of is the same as that of the left gear (69);

3) as illustrated in FIG. 6, fixing and placing the monocrystal silicon substrate into a middle matched hole of the circular retaining frame via the retaining frame (59) and placing the monocrystal silicon substrate between the clamping plates (41) in the working tank (10) such that the retaining frame (59) is engaged with the left gear (69), the right gear (70) and the lower gear (72) under the effect of gravity, rotating the rotatable handle (8) such that the magnetic pole direction of the strip-shaped permanent magnet (25) is consistent with the magnetic pole direction of the square magnet (39) and the arch-shaped electrical soft iron block (23) is quickly magnetized under the effect of the strip-shaped permanent magnet (25) and generates a suction force to tightly retain the square magnet (39), whereby the clamping plates (41) are pulled to generate a clamping force to clamp the monocrystal silicon substrate and fix the retaining frame (59) under a collaborative effect of the hinge plate (40), the clamping plate (41), the fixing hinge (44) and the connection rod (45);

4) adding into deionized water a micron-scale cerium oxide abrasive having a concentration of 3% and a nano-scale diamond abrasive having a concentration of 2%, adding into the deionized water a sub-micron-scale carbonyl iron powder having a concentration of 5% and a micron-scale carbonyl iron powder having a concentration of 3%, and adding a dispersant having a concentration of 4% and a rust inhibitor having a concentration of 2%, sufficiently stirring and performing ultrasonic vibration for 10 minutes, then adding an acid solution having a concentration of 2% that is capable of reacting with the monocrystal silicon substrate, and then performing ultrasonic vibration for 5 minutes to form the magnetorheological fluid (42);

5) pouring the magnetorheological fluid (42) into the working tank (10) such that the magnetorheological fluid overflows the workpiece (68), putting on the groove-shaped end cap (9), starting the translational linear motor (20) to adjust a distance from an end face of the magnet mounting base (46) to front and rear sides of the working tank (10) to be within 1 mm such that the magnetorheological fluid is quickly cured into a flexible polishing pad under the effect of an array of the cylindrical permanent magnets (47), and a staggered symmetric arrangement structure of the magnetic poles implements pressure balance of the workpiece (68);

6) starting the step motor (73) to drive the upper gear (71) to rotate to and drive the fixed retaining frame (59) and the workpiece (68) to rotate, and meanwhile drive the motor (60) to operate, driving the deflection spindle (54) to eccentrically swing around the spindle eccentricity (29) under the effect of the small pulley (32), the large pulley (53) and the V-shaped belt (31), wherein the eccentric swinging of the deflection spindle (54) causes the eccentric camshafts and the cylindrical permanent magnet (47) to rotate simultaneously, such that the static magnetic field line of an end face of the cylindrical permanent magnet (47) is transformed into a dynamic magnetic field line, and the dynamic magnetic field line enables a dynamic distribution of the flexible polishing pad formed by the magnetorheological fluid (42), thereby lowering the rigidity of the flexible polishing pad and recovering the properties of the flexible polishing pad such that the abrasive is self-sharpened;

7) putting on the groove-shaped end cap such that the gear is engaged with the circular retaining frame, starting the step motor to drive the circular retaining frame and the workpiece to rotate, starting the horizontal linear motor (3) and the vertical linear motor (7) to drive the working tank (10) and the workpiece (68) to achieve a precise spiral planar motion, such that the monocrystal silicon substrate and the flexible polishing pad formed by the magnetorheological fluid (42) form a complicated waterfall-like motion, the surface material of the monocrystal silicon substrate is quickly corroded under the effect of the aqua regia, and the flexible polishing pad formed by the magnetorheological fluid (42) mechanically removes a corrosion layer and the surface material of the monocrystal silicon substrate simultaneously;

8) during machining, starting the translational linear motor (20) to adjust the distance from the end face of the magnet mounting base (46) to front and rear sides of the working tank (10) to gradually change from 1 mm to 5 mm within 30 minutes, such that the rigidity of the flexible polishing pad formed by the magnetorheological fluid (42) is gradually lowered, and the force applied to the workpiece (68) is reduced, and a process from rough finishing to precision finishing of the monocrystal silicon substrate is completed;

9) stopping the horizontal linear motor (3) and the vertical linear motor (7), stopping the motor (60) and the step motor, taking off the groove-shaped cap, rotating the rotatable handle (8) such that the magnetic pole direction of the strip-shaped permanent magnet (25) is opposite to the magnetic pole direction of the square magnet (39), the arch-shaped electrical soft iron block (23) is quickly magnetized under the effect of the strip-shaped permanent magnet (25) and generates a force to push the square magnet (39), whereby the clamping plate (41) is pushed to open so as to release the monocrystal silicon substrate under a collaborative effect of the hinge plate (40), the clamping plate (41), the fixing hinge (44) and the connection rod (45), and taking the finished monocrystal silicon substrate; and

10) upon completion of the finishing, starting the translational linear motor (20) to adjust the distance from the end face of the magnet mounting base (46) to the front and rear sides of the working tank (10) to be 10 mm, releasing the bolt (74), and discharging the magnetorheological fluid (42) completing finishing from the working tank (10).

### Embodiment 4

This embodiment is different from Embodiment 2 in that: In this embodiment, double-face polishing is performed for a monocrystal SiC substrate having a diameter of 100 mm, and the method performed by the double-face polishing device capable of controlling rigidity of a polishing pad through a cluster dynamic magnetic field comprises the following steps:

1) according to the dimension and material properties of the monocrystal SiC substrate, designing a double-face polishing device capable of controlling rigidity of a polishing pad through a cluster dynamic magnetic field that matches with the dimension of the workpiece, selecting a cylindrical permanent magnet (47) having a diameter of 15 mm, a height of 20 mm and a magnetic field strength of 5200 Gs and mounting the cylindrical permanent magnet (47) into the double-face polishing device capable of controlling rigidity of a polishing pad through a cluster dynamic magnetic field, rotating a rotatable handle (8) such that a magnetic pole direction of a strip-shaped permanent magnet (25) is vertical to that of a square magnet (39), and fabricating a circular retaining frame which is adaptive to the workpiece in terms of shape and thickness;

2) according to the shape of the monocrystal SiC substrate, selecting an acid and alkaline corrosion resistant plastic to fabricate the retaining frame (59), and ensuring that the thickness of the retaining frame (59) is ⅔ of the workpiece, and the modulus there of is the same as that of the left gear (69);

3) as illustrated in FIG. 6, fixing and placing the monocrystal SiC substrate into a middle matched hole of the circular retaining frame via the retaining frame (59) and placing the monocrystal SiC substrate between the clamping plates (41) in the working tank (10) such that the retaining frame (59) is engaged with the left gear (69), the right gear (70) and the lower gear (72) under the effect of gravity, rotating the rotatable handle (8) such that the magnetic pole direction of the strip-shaped permanent magnet (25) is consistent with the magnetic pole direction of the square magnet (39) and the arch-shaped electrical soft iron block (23) is quickly magnetized under the effect of the strip-shaped permanent magnet (25) and generates a suction force to tightly retain the square magnet (39), whereby the clamping plates (41) are pulled to generate a clamping force to clamp the monocrystal SiC substrate and fix the retaining frame (59) under a collaborative effect of the hinge plate (40), the clamping plate (41), the fixing hinge (44) and the connection rod (45);

4) adding into deionized water a micron-scale diamond abrasive having a concentration of 5% and a nano-scale diamond abrasive having a concentration of 3%, adding into the deionized water a sub-micron-scale carbonyl iron powder having a concentration of 5% and a micron-scale carbonyl iron powder having a concentration of 2%, and adding a dispersant having a concentration of 3% and a rust inhibitor having a concentration of 2%, sufficiently stirring and performing ultrasonic vibration for 10 minutes, then adding a ferric ion that is capable of having a Fenton reaction with the monocrystal SiC substrate, and then performing ultrasonic vibration for 2 minutes to form the magnetorheological fluid (42);

5) screwing on the bolt (74), pouring the magnetorheological fluid (42) into the working tank (10) such that the magnetorheological fluid overflows the workpiece (68), putting on the groove-shaped end cap (9), starting the translational linear motor (20) to adjust a distance from an end face of the magnet mounting base (46) to front and rear sides of the working tank (10) to be within 0.5 mm such that the magnetorheological fluid is quickly cured into a flexible polishing pad under the effect of an array of the cylindrical permanent magnets (47), and a staggered symmetric arrangement structure of the magnetic poles implements pressure balance of the workpiece (68);

6) starting the step motor (73) to drive the upper gear (71) to rotate to and drive the fixed retaining frame (59) and the workpiece (68) to rotate, and meanwhile drive the motor (60) to operate, driving the deflection spindle (54) to eccentrically swing around the spindle eccentricity (29) under the effect of the small pulley (32), the large pulley (53) and the V-shaped belt (31), wherein the eccentric swinging of the deflection spindle (54) causes the eccentric camshafts and the cylindrical permanent magnet (47) to rotate simultaneously, such that the static magnetic field line of an end face of the cylindrical permanent magnet (47) is transformed into a dynamic magnetic field line, and the dynamic magnetic field line enables a dynamic distribution of the flexible polishing pad formed by the magnetorheological fluid (42), thereby lowering the rigidity of the flexible polishing pad and recovering the properties of the flexible polishing pad such that the abrasive is self-sharpened;

7) putting on the groove-shaped end cap such that the gear is engaged with the circular retaining frame, starting the step motor to drive the circular retaining frame and the workpiece to rotate, starting the horizontal linear motor (3) and the vertical linear motor (7) to drive the working tank (10) and the workpiece (68) to achieve a relative planar motion in a predetermined trajectory, such that the monocrystal SiC substrate and the flexible polishing pad formed by the magnetorheological fluid (42) form a complicated waterfall-like motion, the surface material of the monocrystal SiC substrate is quickly corroded under the effect of the Fenton reaction by the trivalent ferric ion, and the flexible polishing pad formed by the magnetorheological fluid (42) mechanically removes a corrosion layer and the surface material of the monocrystal SiC substrate simultaneously;

8) during machining, starting the translational linear motor (20) to adjust the distance from the end face of the magnet mounting base (46) to front and rear sides of the working tank (10) to gradually change from 0.5 mm to 5 mm within 60 minutes, such that the rigidity of the flexible polishing pad formed by the magnetorheological fluid (42) is gradually lowered, and the force applied to the workpiece (68) is reduced, and a process of rough finishing to precision finishing of the monocrystal SiC substrate is completed;

9) stopping the horizontal linear motor (3) and the vertical linear motor (7), stopping the motor (60) and the step motor, taking off the groove-shaped cap, rotating the rotatable handle (8) such that the magnetic pole direction of the strip-shaped permanent magnet (25) is opposite to the magnetic pole direction of the square magnet (39), the arch-shaped electrical soft iron block (23) is quickly magnetized under the effect of the strip-shaped permanent magnet (25) and generates a force to push the square magnet (39), whereby the clamping plate (41) is pushed to open so as to release the monocrystal SiC substrate under a collaborative effect of the hinge plate (40), the clamping plate (41), the fixing hinge (44) and the connection rod (45), and taking the finished monocrystal SiC substrate; and

10) upon completion of the finishing, starting the translational linear motor (20) to adjust the distance from the end face of the magnet mounting base (46) to the front and rear sides of the working tank (10) to be 10 mm, releasing the bolt (74), and discharging the magnetorheological fluid (42) completing finishing from the working tank (10).

### Embodiment 5

This embodiment is different from Embodiment 2 in that: In this embodiment, double-face polishing is performed for an electronic ceramic substrate having a diameter of 100 mm, and the method performed by the double-face polishing device capable of controlling rigidity of a polishing pad through a cluster dynamic magnetic field comprises the following steps:

1) according to the dimension and material properties of the electronic ceramic substrate, designing a variable-rigidity cluster magnetically-controlled waterfall double-face polishing device that matches with the dimension of the workpiece, selecting a cylindrical permanent magnet (47) having a diameter of 15 mm, a height of 15 mm and a magnetic field strength of 4200 Gs and mounting the cylindrical permanent magnet (47) into the variable-rigidity cluster magnetically-controlled waterfall double-face polishing device, rotating a rotatable handle (8) such that a magnetic pole direction of a strip-shaped permanent magnet (25) is vertical to that of a square magnet (39), and fabricating a circular retaining frame which is adaptive to the workpiece in terms of shape and thickness;

2) according to the shape of the electronic ceramic substrate, selecting an epoxy region to fabricate the retaining frame (59), and ensuring that the thickness of the retaining frame (59) is ⅔ of the workpiece, and the modulus there of is the same as that of the left gear (69);

3) as illustrated in FIG. 6, fixing and placing the electronic ceramic substrate into a middle matched hole of the circular retaining frame via the retaining frame (59) and placing the electronic ceramic between the clamping plates (41) in the working tank (10) such that the retaining frame (59) is engaged with the left gear (69), the right gear (70) and the lower gear (72) under the effect of gravity, rotating the rotatable handle (8) such that the magnetic pole direction of the strip-shaped permanent magnet (25) is consistent with the magnetic pole direction of the square magnet (39) and the arch-shaped electrical soft iron block (23) is quickly magnetized under the effect of the strip-shaped permanent magnet (25) and generates a suction force to tightly retain the square magnet (39), whereby the clamping plates (41) are pulled to generate a clamping force to clamp the electronic ceramic substrate and fix the retaining frame (59) under a collaborative effect of the hinge plate (40), the clamping plate (41), the fixing hinge (44) and the connection rod (45);

4) adding into deionized water a micron-scale silicon carbide abrasive having a concentration of 3% and a nano-scale silicon carbide abrasive having a concentration of 2%, adding into the deionized water a sub-micron-scale carbonyl iron powder having a concentration of 5% and a micron-scale carbonyl iron powder having a concentration of 3%, and adding a dispersant having a concentration of 4% and a rust inhibitor having a concentration of 2%, sufficiently stirring and performing ultrasonic vibration for 10 minutes to form the magnetorheological fluid (42);

5) screwing on the bolt (74), pouring the magnetorheological fluid (42) into the working tank (10) such that the magnetorheological fluid overflows the workpiece (68), putting on the groove-shaped end cap (9), starting the translational linear motor (20) to adjust a distance from an end face of the magnet mounting base (46) to front and rear sides of the working tank (10) to be within 1.2 mm such that the magnetorheological fluid is quickly cured into a flexible polishing pad under the effect of an array of the cylindrical permanent magnets (47), and a staggered symmetric arrangement structure of the magnetic poles implements pressure balance of the workpiece (68);

6) starting the step motor (73) to drive the upper gear (71) to rotate to and drive the fixed retaining frame (59) and the workpiece (68) to rotate, and meanwhile drive the motor (60) to operate, driving the deflection spindle (54) to eccentrically swing around the spindle eccentricity (29) under the effect of the small pulley (32), the large pulley (53) and the V-shaped belt (31), wherein the eccentric swinging of the deflection spindle (54) causes the eccentric camshafts and the cylindrical permanent magnet (47) to rotate simultaneously, such that the static magnetic field line of an end face of the cylindrical permanent magnet (47) is transformed into a dynamic magnetic field line, and the dynamic magnetic field line enables a dynamic distribution of the flexible polishing pad formed by the magnetorheological fluid (42), thereby lowering the rigidity of the flexible polishing pad and recovering the properties of the flexible polishing pad such that the abrasive is self-sharpened;

7) putting on the groove-shaped end cap such that the gear is engaged with the circular retaining frame, starting the step motor to drive the circular retaining frame and the workpiece to rotate, starting the horizontal linear motor (3) and the vertical linear motor (7) to drive the working tank (10) and the workpiece (68) to achieve a precise spiral planar motion, such that the electronic ceramic substrate and the flexible polishing pad formed by the magnetorheological fluid (42) form a complicated waterfall-like motion, and the flexible polishing pad formed by the magnetorheological fluid (42) mechanically removes a corrosion layer and the surface material of the electronic ceramic substrate simultaneously;

8) during machining, starting the translational linear motor (20) to adjust the distance from the end face of the magnet mounting base (46) to front and rear sides of the working tank (10) to gradually change from 1.2 mm to 7 mm within 30 minutes, such that the rigidity of the flexible polishing pad formed by the magnetorheological fluid (42) is gradually lowered, and the force applied to the workpiece (68) is reduced, and a process of rough finishing to precision finishing of the electronic ceramic substrate is completed;

9) stopping the horizontal linear motor (3) and the vertical linear motor (7), stopping the motor (60) and the step motor (73), opening the upper groove-shaped cap (9), rotating the rotatable handle (8) such that the magnetic pole direction of the strip-shaped permanent magnet (25) is opposite to the magnetic pole direction of the square magnet (39), the arch-shaped electrical soft iron block (23) is quickly magnetized under the effect of the strip-shaped permanent magnet (25) and generates a force to push the square magnet (39), whereby the clamping plate (41) is pushed to open so as to release the electronic ceramic substrate under a collaborative effect of the hinge plate (40), the clamping plate (41), the fixing hinge (44) and the connection rod (45), and taking the finished electronic ceramic substrate; and

10) starting the translational linear motor (20) to adjust the distance from the end face of the magnet mounting base (46) to the front and rear sides of the working tank (10) to be 10 mm, releasing the bolt (74), and discharging the magnetorheological fluid (42) completing finishing from the working tank (10).

In the double-face polishing device capable of controlling rigidity of a polishing pad through a cluster dynamic magnetic field according to the present invention, firstly, by means of smartly utilizing the feature of quick magnetization and demagnetization of the soft magnetic material, and the feature that the magnetic field is weak in the middle and the magnetic fields at two ends are stronger in a strip-shaped permanent magnet, a parallelogram clamping mechanism having a weak magnetic pole as a primer quickly clamps the workpiece in a closed space. Secondly, the present invention innovatively uses a staggered symmetric arrangement structure of the magnetic poles to implement pressure balance of the workpiece by the polishing pad, and to implement the swinging of the deflection spindle via the eccentric camshaft structure. The swinging of the deflection spindle implements rotation of a plurality of eccentric camshafts having the same eccentricity, such that a plurality of close arrays of permanent magnets simultaneously rotate to cause the static magnetic field line of the end face of the magnetic pole to transform into an intersecting dynamic magnetic field line which enables the flexible polishing pad formed by the magnetorheological fluid to be dynamically distributed. In this way, the rigidity of the flexible polishing pad is lowered and the properties of the flexible polishing pad are recovered. During machining, by symmetrically adjusting the distance from the end face of the variable-rigidity cluster magnetically-controlled polishing pad generating mechanism to the workpiece, the entire process from double-face rough finishing to precision finishing of the workpiece may be completed via one-time machining. The complicated movement trajectory is acquired for the workpiece by a combination of the horizontal linear motor and the vertical linear motor. This prevents the problem that during the machining, the workpiece finishing is not uniform due to inconsistent relative speeds between different positions of the workpiece and the polishing pad. In addition, the double-face polishing device capable of controlling rigidity of a polishing pad through a cluster dynamic magnetic field according to the present invention is applicable to common magnetorheological double-face polishing and magnetorheological chemical mechanical double-face polishing. The desired magnetorheological fluid only needs to be filled to an extremely tiny closed working space, which greatly reduces the cost of the consumable materials. It is apparent that the present invention acquires good workpiece surface consistence, achieves a high machining efficiency, causes no surface and sub-surface damages, and has a low cost, which is thus very applicable to high-efficiency super-smooth planar uniform polishing and finishing of optical elements having a greater diameter.

Described above illustrate in detail the double-face polishing device and method capable of controlling rigidity of a polishing pad through a cluster dynamic magnetic field according to the present invention. Persons of ordinary skill in the art would make modifications to the specific embodiments and application scope without departing from the idea of the embodiments of the present invention. In conclusion, the specification of the present invention shall not be construed as limiting the present invention.

1. A double-face polishing device capable of controlling rigidity of a polishing pad through a cluster dynamic magnetic field, comprising a variable-rigidity cluster magnetically-controlled polishing pad generating mechanism, a workpiece fast clamping mechanism and a workpiece movement driving mechanism, wherein
the variable-rigidity cluster magnetically-controlled polishing pad generating mechanism comprises a first magnetic field generating block and a second magnetic field generating block that are symmetrically arranged, the first magnetic field generating block and the second magnetic field generating block each comprise a shell, a deflection spindle, an eccentric camshaft, a magnet mounting base, a permanent magnet and a motor,
wherein one ends of an even number of permanent magnets are mounted on the magnet mounting base having an even number of array holes, and the other ends of the even number of permanent magnets are mounted in an end face of the eccentric camshaft,
wherein a large end of the deflection spindle is connected to the eccentric camshaft and a shaft end of the deflection spindle is connected and fixed to the shell, and the motor is fixed on the shell, and drives the deflection spindle by using a transmission mechanism, and
wherein the first magnetic field generating block and the second magnetic generating block move towards each other forward and backward under an effect of an opposing movement mechanism;
the workpiece fast clamping mechanism comprises a working tank, a clamping plate, a connection rod, a hinge plate, a fixing hinge, a square magnet, an electrical soft iron block, an annular cast iron and a strip-shaped permanent magnet,
wherein the working tank is arranged between the first magnetic field generating block and the second magnetic field generating block, a machining space accommodating a workpiece is formed in a middle part of the working tank,
wherein two ends of the working tank are each provided with the clamping plate, an outer side face of the clamping plate being movably connected to an inner wall of the working tank via two parallel connection rods; the inner wall of the working tank, the clamping plate, and the two corresponding connection rods form a parallelogram,
wherein an annular structure, formed between two end faces of the clamping plate, stretches into the machining space to clamp the workpiece, one end of the clamping plate being movably connected to one end of the hinge plate, and the other end of the hinge plate being connected to one end of the fixing hinge via a movable hinge,
wherein the other end of the fixing hinge is fixedly connected to a square protection sleeve provided with the square magnet; two electrical soft iron blocks are arranged at the two ends of the working tank, and are arranged to match with two square magnets, and
wherein the two electrical soft iron blocks are connected to a cuboid having a cylindrical hole in a middle part via brass, the cylindrical hole is provided with the annular cast iron, and the bar permanent magnet is mounted in the annular cast iron; and
the workpiece movement driving mechanism comprises a support block, a cross beam, a horizontal linear motor, a vertical beam and a vertical linear motor,
wherein the support block is symmetrically arranged above a base of the double-face polishing device, two ends of the horizontal linear motor above which the cross beam is mounted are fixed to an upper part of the support block, the vertical beam is fixed and mounted on two ends of the cross beam, the vertical linear motor is mounted on the vertical beam, and left and right side faces of the working tank are fixed to the vertical linear motor.

2. The double-face polishing device capable of controlling rigidity of a polishing pad through a cluster dynamic magnetic field according to claim 1, wherein the opposing movement mechanism 2 comprises a translational linear motor, a precision double-sided rack and two precision single-sided racks, wherein
the translational linear motor is mounted above the base, the precision double-sided rack having a symmetric structure is mounted on the translational linear motor, and two sides of the precision double-sided rack are respectively engaged with the two precision single-side racks via a gear, wherein the two precision single-sided racks are mounted on the base via a front and rear linear guide rail, and are respectively arranged on the two sides of the precision double-sided rack; and
the shells of the first magnetic field generating block and the second magnetic field generating block are respectively connected to the precision double-sided rack and the two precision single-sided racks.

3. The double-face polishing device capable of controlling rigidity of a polishing pad through a cluster dynamic magnetic field according to claim 1, wherein the transmission mechanism comprises a small pulley, a large pulley, a small flat key, a large flat key and a V-shaped belt, wherein
the small pulley is fixed to the motor shaft of the motor via the small flat key and the large pulley is fixed to the deflection spindle via the large flat key, and the small pulley and the large pulley are connected via the V-shaped belt.

4. The double-face polishing device capable of controlling rigidity of a polishing pad through a cluster dynamic magnetic field according to claim 1, wherein a spindle eccentricity is present at a shaft-end bearing of the deflection spindle, and a camshaft eccentricity is present at a small-shaft-end bearing of the eccentric camshaft, wherein the spindle eccentricity and the camshaft eccentricity have the same value but have opposite eccentric directions.

5. The double-face polishing device capable of controlling rigidity of a polishing pad through a cluster dynamic magnetic field according to claim 1, wherein the permanent magnet has a magnetic field strength of between 1000 Gs and 5500 Gs, the square magnet has a magnetic field strength of between 200 Gs and 1200 Gs, the strip-shaped permanent magnet has a magnetic field strength of between 2000 Gs and 4000 Gs, neighboring cylindrical permanent magnets mounted on the same magnetic mounting base are distributed with opposite polarities, and cylindrical permanent magnets mounted on different magnetic mounting bases are arranged in mutually opposed pairs and are anisotropic in approximation to short magnetic poles.

6. The double-face polishing device capable of controlling rigidity of a polishing pad through a cluster dynamic magnetic field according to claim 1, wherein the workpiece fast clamping mechanism further comprises a circular retaining frame configured to receive the workpiece, and a left gear, a right gear, an upper gear and a lower gear arranged in the periphery of the circular retaining frame and engaging with an arc side of the circular retaining frame, wherein
the left gear, the right gear, the upper gear and the lower gear are mounted in the working tank, the left gear and the right gear are symmetrically mounted, and the upper gear and the lower gear are symmetrically mounted; and
at least one of the left gear, the right gear, the upper gear and the lower gear is connected to a step motor.

7. A double-face polishing method capable of controlling rigidity of a polishing pad through a cluster dynamic magnetic field, which is applied in the double-face polishing device capable of controlling rigidity of a polishing pad through a cluster dynamic magnetic field as defined in claim 1, comprising:
selecting the permanent magnets having a corresponding magnetic field strength according to a dimension and material properties of the workpiece, and adjusting a position of the strip-shaped permanent magnet such that a magnetic pole direction of the strip-shaped permanent magnet is vertical to that of the square magnet;
placing the workpiece into the working tank and causing an edge of the workpiece to be arranged between the clamping plates, adjusting the position of the strip-shaped permanent magnet, such that the magnetic pole direction of the strip-shaped permanent magnet is consistent with that of the square magnet, the electrical soft iron block is quickly magnetized under the effect of the strip-shaped permanent magnet and generates a suction force to tightly retain the square magnet, whereby the clamping plates are pulled to generate a clamping force to clamp the workpiece under a collaborative effect of the hinge plate, the clamping plate, the fixing hinge and the connection rod;
adding into deionized water at least two abrasives of the three abrasives including a micron-scale abrasive having a concentration of 3% to 8%, a sub-micron-scale abrasive having a concentration of 3% to 10% and a nano-scale abrasive having a concentration of 2% to 10%, and adding into the deionized water a sub-micron-scale carbonyl iron powder having a concentration of 5% to 20% and a micro-scale carbonyl iron powder having a concentration of 5% to 25%, and adding a dispersant having a concentration of 3% to 15% and a rust inhibitor having a concentration of 1% to 6%, sufficiently stirring and performing ultrasonic vibration for 5 to 30 minutes, then selectively adding a chemical liquid having a concentration of 1% to 10% that is capable of reacting with the workpiece and selectively adding a catalyst that is capable of accelerating the reaction of the workpiece with the chemical liquid, and then performing ultrasonic vibration for 2 to 10 minutes to form a magnetorheological fluid;
pouring the magnetorheological fluid into the working tank such that the magnetorheological overflows the workpiece, adjusting a distance from an end face of the magnet mounting base to front and rear sides of the working tank to be within 0.5 mm to 10 mm by using the opposing movement mechanism such that the magnetorheological fluid is quickly cured into a flexible polishing pad under an effect of an array of the permanent magnets, and a staggered symmetric arrangement structure of the magnetic poles implements pressure balance of the workpiece;
starting the motor to drive the deflection spindle to eccentrically swing around a spindle eccentricity, wherein an eccentric swinging of the deflection spindle causes each eccentric camshaft and a cylindrical permanent magnet to rotate simultaneously, such that a static magnetic field line of an end face of the cylindrical permanent magnet is transformed into a dynamic magnetic field line;
starting the horizontal linear motor and the vertical linear motor to drive the working tank and the workpiece to move, such that the workpiece and the flexible polishing pad formed by the magnetorheological fluid are subjected to a planar relative movement in a predetermined trajectory, and the flexible polishing pad formed by the magnetorheological fluid mechanically removes materials on both surfaces and a corrosion layer of the workpiece simultaneously;
during a finishing process, by an adjustment using the opposing movement mechanism, gradually increasing the distance from the end face of the magnet mounting base to the front and rear sides of the working tank, such that a rigidity of the flexible polishing pad formed by the magnetorheological fluid is further lowered, the force applied to the workpiece is reduced, and the overall finishing process, comprising from a rough finishing to a precision finishing, is completed; and
stopping the horizontal linear motor, the vertical linear motor and the motor, adjusting the position of the strip-shaped permanent magnet such that the magnetic pole direction of the strip-shaped permanent magnet is opposite to the magnetic pole direction of the square magnet, and releasing and taking out the workpiece.

8. The double-face polishing device capable of controlling rigidity of a polishing pad through a cluster dynamic magnetic field according to claim 7, wherein the workpiece is a glass substrate, a monocrystal SiC substrate, a monocrystal Si substrate, a sapphire substrate, a polycrystal semiconductor substrate, a ceramic substrate or a metal substrate.

9. A double-face polishing method capable of controlling rigidity of a polishing pad through a cluster dynamic magnetic field, which is applied in the double-face polishing device capable of controlling rigidity of a polishing pad through a cluster dynamic magnetic field as defined in claim 2, comprising:
selecting the permanent magnets having a corresponding magnetic field strength according to a dimension and material properties of the workpiece, and adjusting a position of the strip-shaped permanent magnet such that a magnetic pole direction of the strip-shaped permanent magnet is vertical to that of the square magnet;
placing the workpiece into the working tank and causing an edge of the workpiece to be arranged between the clamping plates, adjusting the position of the strip-shaped permanent magnet, such that the magnetic pole direction of the strip-shaped permanent magnet is consistent with that of the square magnet, the electrical soft iron block is quickly magnetized under the effect of the strip-shaped permanent magnet and generates a suction force to tightly retain the square magnet, whereby the clamping plates are pulled to generate a clamping force to clamp the workpiece under a collaborative effect of the hinge plate, the clamping plate, the fixing hinge and the connection rod;
adding into deionized water at least two abrasives of the three abrasives including a micron-scale abrasive having a concentration of 3% to 8%, a sub-micron-scale abrasive having a concentration of 3% to 10% and a nano-scale abrasive having a concentration of 2% to 10%, and adding into the deionized water a sub-micron-scale carbonyl iron powder having a concentration of 5% to 20% and a micro-scale carbonyl iron powder having a concentration of 5% to 25%, and adding a dispersant having a concentration of 3% to 15% and a rust inhibitor having a concentration of 1% to 6%, sufficiently stirring and performing ultrasonic vibration for 5 to 30 minutes, then selectively adding a chemical liquid having a concentration of 1% to 10% that is capable of reacting with the workpiece and selectively adding a catalyst that is capable of accelerating the reaction of the workpiece with the chemical liquid, and then performing ultrasonic vibration for 2 to 10 minutes to form a magnetorheological fluid;
pouring the magnetorheological fluid into the working tank such that the magnetorheological overflows the workpiece, adjusting a distance from an end face of the magnet mounting base to front and rear sides of the working tank to be within 0.5 mm to 10 mm by using the opposing movement mechanism such that the magnetorheological fluid is quickly cured into a flexible polishing pad under an effect of an array of the permanent magnets, and a staggered symmetric arrangement structure of the magnetic poles implements pressure balance of the workpiece;
starting the motor to drive the deflection spindle to eccentrically swing around a spindle eccentricity, wherein an eccentric swinging of the deflection spindle causes each eccentric camshaft and a cylindrical permanent magnet to rotate simultaneously, such that a static magnetic field line of an end face of the cylindrical permanent magnet is transformed into a dynamic magnetic field line;
starting the horizontal linear motor and the vertical linear motor to drive the working tank and the workpiece to move, such that the workpiece and the flexible polishing pad formed by the magnetorheological fluid are subjected to a planar relative movement in a predetermined trajectory, and the flexible polishing pad formed by the magnetorheological fluid mechanically removes materials on both surfaces and a corrosion layer of the workpiece simultaneously;
during a finishing process, by an adjustment using the opposing movement mechanism, gradually increasing the distance from the end face of the magnet mounting base to the front and rear sides of the working tank, such that a rigidity of the flexible polishing pad formed by the magnetorheological fluid is further lowered, the force applied to the workpiece is reduced, and the overall finishing process, comprising from a rough finishing to a precision finishing, is completed; and
stopping the horizontal linear motor, the vertical linear motor and the motor, adjusting the position of the strip-shaped permanent magnet such that the magnetic pole direction of the strip-shaped permanent magnet is opposite to the magnetic pole direction of the square magnet, and releasing and taking out the workpiece.

10. The double-face polishing device capable of controlling rigidity of a polishing pad through a cluster dynamic magnetic field according to claim 9, wherein the workpiece is a glass substrate, a monocrystal SiC substrate, a monocrystal Si substrate, a sapphire substrate, a polycrystal semiconductor substrate, a ceramic substrate or a metal substrate.

11. A double-face polishing method capable of controlling rigidity of a polishing pad through a cluster dynamic magnetic field, which is applied in the double-face polishing device capable of controlling rigidity of a polishing pad through a cluster dynamic magnetic field as defined in claim 3, comprising:
selecting the permanent magnets having a corresponding magnetic field strength according to a dimension and material properties of the workpiece, and adjusting a position of the strip-shaped permanent magnet such that a magnetic pole direction of the strip-shaped permanent magnet is vertical to that of the square magnet;
placing the workpiece into the working tank and causing an edge of the workpiece to be arranged between the clamping plates, adjusting the position of the strip-shaped permanent magnet, such that the magnetic pole direction of the strip-shaped permanent magnet is consistent with that of the square magnet, the electrical soft iron block is quickly magnetized under the effect of the strip-shaped permanent magnet and generates a suction force to tightly retain the square magnet, whereby the clamping plates are pulled to generate a clamping force to clamp the workpiece under a collaborative effect of the hinge plate, the clamping plate, the fixing hinge and the connection rod;
adding into deionized water at least two abrasives of the three abrasives including a micron-scale abrasive having a concentration of 3% to 8%, a sub-micron-scale abrasive having a concentration of 3% to 10% and a nano-scale abrasive having a concentration of 2% to 10%, and adding into the deionized water a sub-micron-scale carbonyl iron powder having a concentration of 5% to 20% and a micro-scale carbonyl iron powder having a concentration of 5% to 25%, and adding a dispersant having a concentration of 3% to 15% and a rust inhibitor having a concentration of 1% to 6%, sufficiently stirring and performing ultrasonic vibration for 5 to 30 minutes, then selectively adding a chemical liquid having a concentration of 1% to 10% that is capable of reacting with the workpiece and selectively adding a catalyst that is capable of accelerating the reaction of the workpiece with the chemical liquid, and then performing ultrasonic vibration for 2 to 10 minutes to form a magnetorheological fluid;
pouring the magnetorheological fluid into the working tank such that the magnetorheological overflows the workpiece, adjusting a distance from an end face of the magnet mounting base to front and rear sides of the working tank to be within 0.5 mm to 10 mm by using the opposing movement mechanism such that the magnetorheological fluid is quickly cured into a flexible polishing pad under an effect of an array of the permanent magnets, and a staggered symmetric arrangement structure of the magnetic poles implements pressure balance of the workpiece;
starting the motor to drive the deflection spindle to eccentrically swing around a spindle eccentricity, wherein an eccentric swinging of the deflection spindle causes each eccentric camshaft and a cylindrical permanent magnet to rotate simultaneously, such that a static magnetic field line of an end face of the cylindrical permanent magnet is transformed into a dynamic magnetic field line;
starting the horizontal linear motor and the vertical linear motor to drive the working tank and the workpiece to move, such that the workpiece and the flexible polishing pad formed by the magnetorheological fluid are subjected to a planar relative movement in a predetermined trajectory, and the flexible polishing pad formed by the magnetorheological fluid mechanically removes materials on both surfaces and a corrosion layer of the workpiece simultaneously;
during a finishing process, by an adjustment using the opposing movement mechanism, gradually increasing the distance from the end face of the magnet mounting base to the front and rear sides of the working tank, such that a rigidity of the flexible polishing pad formed by the magnetorheological fluid is further lowered, the force applied to the workpiece is reduced, and the overall finishing process, comprising from a rough finishing to a precision finishing, is completed; and
stopping the horizontal linear motor, the vertical linear motor and the motor, adjusting the position of the strip-shaped permanent magnet such that the magnetic pole direction of the strip-shaped permanent magnet is opposite to the magnetic pole direction of the square magnet, and releasing and taking out the workpiece.

12. The double-face polishing device capable of controlling rigidity of a polishing pad through a cluster dynamic magnetic field according to claim 11, wherein the workpiece is a glass substrate, a monocrystal SiC substrate, a monocrystal Si substrate, a sapphire substrate, a polycrystal semiconductor substrate, a ceramic substrate or a metal substrate.

13. A double-face polishing method capable of controlling rigidity of a polishing pad through a cluster dynamic magnetic field, which is applied in the double-face polishing device capable of controlling rigidity of a polishing pad through a cluster dynamic magnetic field as defined in claim 4, comprising:
selecting the permanent magnets having a corresponding magnetic field strength according to a dimension and material properties of the workpiece, and adjusting a position of the strip-shaped permanent magnet such that a magnetic pole direction of the strip-shaped permanent magnet is vertical to that of the square magnet;
placing the workpiece into the working tank and causing an edge of the workpiece to be arranged between the clamping plates, adjusting the position of the strip-shaped permanent magnet, such that the magnetic pole direction of the strip-shaped permanent magnet is consistent with that of the square magnet, the electrical soft iron block is quickly magnetized under the effect of the strip-shaped permanent magnet and generates a suction force to tightly retain the square magnet, whereby the clamping plates are pulled to generate a clamping force to clamp the workpiece under a collaborative effect of the hinge plate, the clamping plate, the fixing hinge and the connection rod;
adding into deionized water at least two abrasives of the three abrasives including a micron-scale abrasive having a concentration of 3% to 8%, a sub-micron-scale abrasive having a concentration of 3% to 10% and a nano-scale abrasive having a concentration of 2% to 10%, and adding into the deionized water a sub-micron-scale carbonyl iron powder having a concentration of 5% to 20% and a micro-scale carbonyl iron powder having a concentration of 5% to 25%, and adding a dispersant having a concentration of 3% to 15% and a rust inhibitor having a concentration of 1% to 6%, sufficiently stirring and performing ultrasonic vibration for 5 to 30 minutes, then selectively adding a chemical liquid having a concentration of 1% to 10% that is capable of reacting with the workpiece and selectively adding a catalyst that is capable of accelerating the reaction of the workpiece with the chemical liquid, and then performing ultrasonic vibration for 2 to 10 minutes to form a magnetorheological fluid;
pouring the magnetorheological fluid into the working tank such that the magnetorheological overflows the workpiece, adjusting a distance from an end face of the magnet mounting base to front and rear sides of the working tank to be within 0.5 mm to 10 mm by using the opposing movement mechanism such that the magnetorheological fluid is quickly cured into a flexible polishing pad under an effect of an array of the permanent magnets, and a staggered symmetric arrangement structure of the magnetic poles implements pressure balance of the workpiece;
starting the motor to drive the deflection spindle to eccentrically swing around the spindle eccentricity, wherein an eccentric swinging of the deflection spindle causes each eccentric camshaft and the cylindrical permanent magnet to rotate simultaneously, such that a static magnetic field line of an end face of the cylindrical permanent magnet is transformed into a dynamic magnetic field line;
starting the horizontal linear motor and the vertical linear motor to drive the working tank and the workpiece to move, such that the workpiece and the flexible polishing pad formed by the magnetorheological fluid are subjected to a planar relative movement in a predetermined trajectory, and the flexible polishing pad formed by the magnetorheological fluid mechanically removes materials on both surfaces and a corrosion layer of the workpiece simultaneously;
during a finishing process, by an adjustment using the opposing movement mechanism, gradually increasing the distance from the end face of the magnet mounting base to the front and rear sides of the working tank, such that a rigidity of the flexible polishing pad formed by the magnetorheological fluid is further lowered, the force applied to the workpiece is reduced, and the overall finishing process, comprising from a rough finishing to a precision finishing, is completed; and
stopping the horizontal linear motor, the vertical linear motor and the motor, adjusting the position of the strip-shaped permanent magnet such that the magnetic pole direction of the strip-shaped permanent magnet is opposite to the magnetic pole direction of the square magnet, and releasing and taking out the workpiece.

14. The double-face polishing device capable of controlling rigidity of a polishing pad through a cluster dynamic magnetic field according to claim 13, wherein the workpiece is a glass substrate, a monocrystal SiC substrate, a monocrystal Si substrate, a sapphire substrate, a polycrystal semiconductor substrate, a ceramic substrate or a metal substrate.

15. A double-face polishing method capable of controlling rigidity of a polishing pad through a cluster dynamic magnetic field, which is applied in the double-face polishing device capable of controlling rigidity of a polishing pad through a cluster dynamic magnetic field as defined in claim 5, comprising:
selecting the permanent magnets having a corresponding magnetic field strength according to a dimension and material properties of the workpiece, and adjusting a position of the strip-shaped permanent magnet such that a magnetic pole direction of the strip-shaped permanent magnet is vertical to that of the square magnet;
placing the workpiece into the working tank and causing an edge of the workpiece to be arranged between the clamping plates, adjusting the position of the strip-shaped permanent magnet, such that the magnetic pole direction of the strip-shaped permanent magnet is consistent with that of the square magnet, the electrical soft iron block is quickly magnetized under the effect of the strip-shaped permanent magnet and generates a suction force to tightly retain the square magnet, whereby the clamping plates are pulled to generate a clamping force to clamp the workpiece under a collaborative effect of the hinge plate, the clamping plate, the fixing hinge and the connection rod;
adding into deionized water at least two abrasives of the three abrasives including a micron-scale abrasive having a concentration of 3% to 8%, a sub-micron-scale abrasive having a concentration of 3% to 10% and a nano-scale abrasive having a concentration of 2% to 10%, and adding into the deionized water a sub-micron-scale carbonyl iron powder having a concentration of 5% to 20% and a micro-scale carbonyl iron powder having a concentration of 5% to 25%, and adding a dispersant having a concentration of 3% to 15% and a rust inhibitor having a concentration of 1% to 6%, sufficiently stirring and performing ultrasonic vibration for 5 to 30 minutes, then selectively adding a chemical liquid having a concentration of 1% to 10% that is capable of reacting with the workpiece and selectively adding a catalyst that is capable of accelerating the reaction of the workpiece with the chemical liquid, and then performing ultrasonic vibration for 2 to 10 minutes to form a magnetorheological fluid;
pouring the magnetorheological fluid into the working tank such that the magnetorheological overflows the workpiece, adjusting a distance from an end face of the magnet mounting base to front and rear sides of the working tank to be within 0.5 mm to 10 mm by using the opposing movement mechanism such that the magnetorheological fluid is quickly cured into a flexible polishing pad under an effect of an array of the permanent magnets, and a staggered symmetric arrangement structure of the magnetic poles implements pressure balance of the workpiece;
starting the motor to drive the deflection spindle to eccentrically swing around a spindle eccentricity, wherein an eccentric swinging of the deflection spindle causes each eccentric camshaft and a cylindrical permanent magnet to rotate simultaneously, such that a static magnetic field line of an end face of the cylindrical permanent magnet is transformed into a dynamic magnetic field line;
starting the horizontal linear motor and the vertical linear motor to drive the working tank and the workpiece to move, such that the workpiece and the flexible polishing pad formed by the magnetorheological fluid are subjected to a planar relative movement in a predetermined trajectory, and the flexible polishing pad formed by the magnetorheological fluid mechanically removes materials on both surfaces and a corrosion layer of the workpiece simultaneously;
during a finishing process, by an adjustment using the opposing movement mechanism, gradually increasing the distance from the end face of the magnet mounting base to the front and rear sides of the working tank, such that a rigidity of the flexible polishing pad formed by the magnetorheological fluid is further lowered, the force applied to the workpiece is reduced, and the overall finishing process, comprising from a rough finishing to a precision finishing, is completed; and
stopping the horizontal linear motor, the vertical linear motor and the motor, adjusting the position of the strip-shaped permanent magnet such that the magnetic pole direction of the strip-shaped permanent magnet is opposite to the magnetic pole direction of the square magnet, and releasing and taking out the workpiece.

16. The double-face polishing device capable of controlling rigidity of a polishing pad through a cluster dynamic magnetic field according to claim 15 wherein the workpiece is a glass substrate, a monocrystal SiC substrate, a monocrystal Si substrate, a sapphire substrate, a polycrystal semiconductor substrate, a ceramic substrate or a metal substrate.

17. A double-face polishing method capable of controlling rigidity of a polishing pad through a cluster dynamic magnetic field, which is applied in the double-face polishing device capable of controlling rigidity of a polishing pad through a cluster dynamic magnetic field as defined in claim 6, comprising:
selecting the permanent magnets having a corresponding magnetic field strength according to a dimension and material properties of the workpiece, and adjusting a position of the strip-shaped permanent magnet such that a magnetic pole direction of the strip-shaped permanent magnet is vertical to that of the square magnet;
placing the workpiece into the working tank and causing an edge of the workpiece to be arranged between the clamping plates, adjusting the position of the strip-shaped permanent magnet, such that the magnetic pole direction of the strip-shaped permanent magnet is consistent with that of the square magnet, the electrical soft iron block is quickly magnetized under the effect of the strip-shaped permanent magnet and generates a suction force to tightly retain the square magnet, whereby the clamping plates are pulled to generate a clamping force to clamp the workpiece under a collaborative effect of the hinge plate, the clamping plate, the fixing hinge and the connection rod;
adding into deionized water at least two abrasives of the three abrasives including a micron-scale abrasive having a concentration of 3% to 8%, a sub-micron-scale abrasive having a concentration of 3% to 10% and a nano-scale abrasive having a concentration of 2% to 10%, and adding into the deionized water a sub-micron-scale carbonyl iron powder having a concentration of 5% to 20% and a micro-scale carbonyl iron powder having a concentration of 5% to 25%, and adding a dispersant having a concentration of 3% to 15% and a rust inhibitor having a concentration of 1% to 6%, sufficiently stirring and performing ultrasonic vibration for 5 to 30 minutes, then selectively adding a chemical liquid having a concentration of 1% to 10% that is capable of reacting with the workpiece and selectively adding a catalyst that is capable of accelerating the reaction of the workpiece with the chemical liquid, and then performing ultrasonic vibration for 2 to 10 minutes to form a magnetorheological fluid;
pouring the magnetorheological fluid into the working tank such that the magnetorheological overflows the workpiece, adjusting a distance from an end face of the magnet mounting base to front and rear sides of the working tank to be within 0.5 mm to 10 mm by using the opposing movement mechanism such that the magnetorheological fluid is quickly cured into a flexible polishing pad under an effect of an array of the permanent magnets, and a staggered symmetric arrangement structure of the magnetic poles implements pressure balance of the workpiece;
starting the motor to drive the deflection spindle to eccentrically swing around a spindle eccentricity, wherein an eccentric swinging of the deflection spindle causes each eccentric camshaft and a cylindrical permanent magnet to rotate simultaneously, such that a static magnetic field line of an end face of the cylindrical permanent magnet is transformed into a dynamic magnetic field line;
starting the horizontal linear motor and the vertical linear motor to drive the working tank and the workpiece to move, such that the workpiece and the flexible polishing pad formed by the magnetorheological fluid are subjected to a planar relative movement in a predetermined trajectory, and the flexible polishing pad formed by the magnetorheological fluid mechanically removes materials on both surfaces and a corrosion layer of the workpiece simultaneously;
during a finishing process, by an adjustment using the opposing movement mechanism, gradually increasing the distance from the end face of the magnet mounting base to the front and rear sides of the working tank, such that a rigidity of the flexible polishing pad formed by the magnetorheological fluid is further lowered, the force applied to the workpiece is reduced, and the overall finishing process, comprising from a rough finishing to a precision finishing, is completed; and
stopping the horizontal linear motor, the vertical linear motor and the motor, adjusting the position of the strip-shaped permanent magnet such that the magnetic pole direction of the strip-shaped permanent magnet is opposite to the magnetic pole direction of the square magnet, and releasing and taking out the workpiece.

18. The double-face polishing device capable of controlling rigidity of a polishing pad through a cluster dynamic magnetic field according to claim 17, wherein the workpiece is a glass substrate, a monocrystal SiC substrate, a monocrystal Si substrate, a sapphire substrate, a polycrystal semiconductor substrate, a ceramic substrate or a metal substrate.
